(19) United States
(12) Patent Application Publication
(10) Pub. No.: US 2025/0285320 A1
(43) Pub. Date: Sep. 11, 2025

(54) OWN POSITION ESTIMATING SYSTEM AND OWN POSITION ESTIMATING METHOD

(71) Applicant: KAWASAKI JUKOGYO KABUSHIKI KAISHA, Hyogo (JP)

(72) Inventors: Masaomi IIDA, Kobe-shi, Hyogo (JP); Tomomi SANO, Kobe-shi, Hyogo (JP)

(73) Assignee: KAWASAKI JUKOGYO KABUSHIKI KAISHA, Hyogo (JP)

(21) Appl. No.: 18/280,948

(22) PCT Filed: Mar. 10, 2021
(86) PCT No.: PCT/JP2021/009607

§ 371 Date: Mar. 5, 2024

(51) Int. Cl. G06T 7/73; G01C 21/00; G06T 7/579; G06T 7/593; H04N 9/31

(52) U.S. Cl. CPC G06T 7/73; G01C 21/005; G06T 7/579; G06T 7/593; G06T 2207/30164; G06T 2207/30204; G06T 2207/30244; G06T 2207/30252; H04N 9/3173

(57) ABSTRACT

A work information projection system estimates a position in a workplace. The work information projections system includes a camera (13), a stereo camera (14), and a controller. The camera (13) is arranged facing in a first direction and acquires first environment information which is information about an object arranged in and around the first direction. The stereo camera (14) is arranged facing in a second direction and acquires second environment information which is information about an object arranged in and around the second direction. The controller estimates a position in a first coordinate system based on the first environment information when it determines that the second environment information becomes unacquirable.

### TECHNICAL FIELD

This application mainly relates to a self-position estimation system that estimates a self-position in a workplace.

### BACKGROUND ART

PTL 1 discloses a system that includes a worker terminal and a controller. The worker terminal is attached to a worker's head. The worker terminal includes a stereo camera and a projector. The controller creates map information that indicates a shape and a position of an object in a workplace based on an image captured by the stereo camera. The controller further estimates a position of the stereo camera (that is, a position of the worker terminal) in the map information. The controller creates an image according to the position of the worker terminal and transmits it to the projector. The projector projects the image created by the controller onto the workplace. In this manner, the system can assist the work by projecting the image according to the position of the worker terminal. [PTL 1] Japanese Patent Application Publication No. 2020-98451.

### SUMMARY OF THE INVENTION

### Problems to be Solved by the Invention

In the system of PTL 1, if the stereo camera becomes unable to acquire the shape and the position of the object in the workplace, the position of the worker terminal cannot be accurately estimated.

The present invention is made in view of the situation describe above and its main purpose is to provide a system that can continue the estimation of the self-position even when one sensor becomes unable to acquire the environment around the workplace.

### Means for Solving the Problems

The problem to be solved by the present invention is as described above. The means to solve this problem and the effects thereof will be described below.

A first aspect of the present invention provides a position estimation system with a configuration described below. That is, the position estimation system estimates a position in a workplace. The position estimation system includes a first sensor, a second sensor, and a controller. The first sensor is arranged facing in a first direction and acquires first environment information which is information about an object arranged in and around the first direction. The second sensor is arranged facing in a second direction and acquires second environment information which is information about an object arranged in and around the second direction. The controller can calculate a self-position in a first coordinate system based on the first environment information and can calculate a self-position in a second coordinate system based on the second environment information. The controller estimates a self-position based on the first environment information when the second environment information becomes unacquirable.

A second aspect of the present invention provides a position estimation method as follows. That is, the position estimation method includes a first acquisition process, a second acquisition process, and a position estimation process. In the first acquisition process, first environment information which is information about an object arranged in and around a first direction is acquired by a first sensor arranged in a workplace facing in the first direction. In the second acquisition process, second environment information which is information about an object arranged in and around a second direction is acquired by a second sensor arranged in the workplace facing in the second direction. In the position estimation process, a self-position is estimated based on the first environment information when the second environment information becomes unacquirable.

This allows the estimation of the position in the workplace to be continued even when the second sensor becomes unable to acquire the environment information.

The present invention provides a system that can continue estimation of a self-position even when one sensor becomes unable to acquire the environment around the workplace.

### BRIEF DESCRIPTION OF THE DRAWINGS

FIG. 1 is a schematic drawing of a work information projection system according to one embodiment of the present invention.

FIG. 2 is a block diagram of a work information projection system.

FIG. 3 is a flowchart showing a calibration process.

FIG. 4 is a perspective view showing a calibration image being projected onto a calibration jig.

FIG. 5 is a perspective view showing a workpiece being measured with a reference marker installed on it.

FIG. 6 is a flowchart showing a process performed during a work.

FIG. 7 is a drawing that illustrates a situation where a SLAM measurement is performed and a situation where conversion information is calculated while performing a SLAM measurement.

FIG. 8 is a drawing that illustrates a situation where a marker measurement is performed and a situation where a SLAM measurement is performed again.

### EMBODIMENT FOR CARRYING OUT THE INVENTION

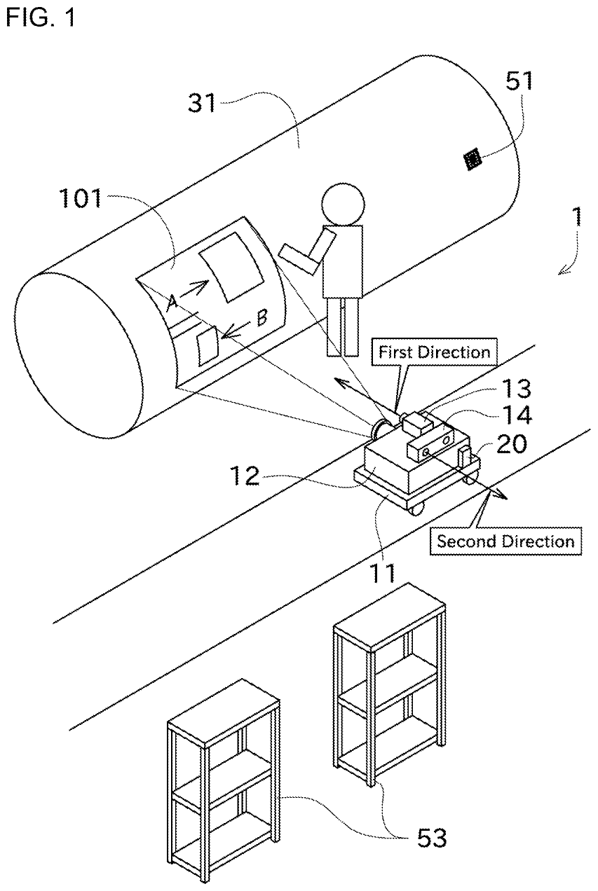

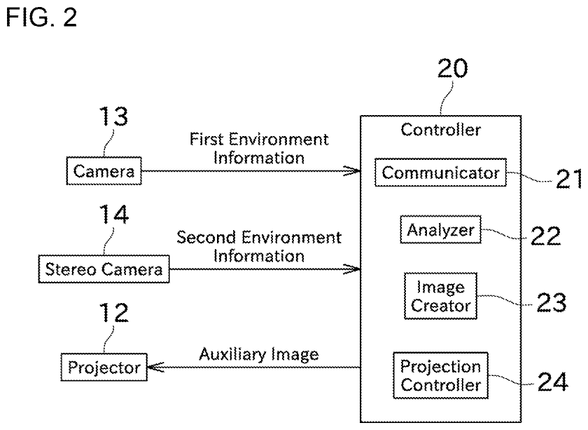

An embodiment of the present invention will be described below with reference to the drawings. First, outlines of a work information projection system 1 and a position recognition method will be described below with reference to FIG. 1 and FIG. 2.

The work information projection system (position recognition system) 1 of the present embodiment is arranged in a workplace. The workplace is a place where a work is performed, such as a factory, an office, or an institution. The work is something that a worker does to an object by hand, using a tool, or operating a machine, such as assembling parts, painting, cleaning, or transfer. In the present embodiment, the worker performs the work of attaching a part to a workpiece 31 arranged in a factory.

The work information projection system 1 recognizes a position in the workplace and projects an auxiliary image 101 onto the workplace based on the recognized position. The auxiliary image 101 is an image that assists the work, such as an image that conveys content of the work, a position to perform the work, an order of the work, or the like to the worker. As shown in FIG. 1, the auxiliary image 101 of the present embodiment is projected onto the workpiece 31 and indicates a name of a part to be attached and a position where to attach it. The work information projection system 1 recognizes a position of the workpiece 31 (details of this process will be described below) and projects the auxiliary image 101 onto the workpiece 31 at an appropriate position.

As shown in FIG. 1 and FIG. 2, the work information projection system 1 includes a cart 11, a projector 12, a camera 13, a stereo camera 14, and a controller 20. In the following description, unless otherwise specified, the meaning of the term “position” shall include not only a location of an object, but also a direction in which the object is facing. Thus, for example, the meaning of the term “positional relation” includes not only the relative positions of two objects, but also their relative orientations.

The cart 11 includes wheels and a base. The cart 11 of the present embodiment does not include a drive source and moves in the workplace by being pushed by the worker. The cart 11 may include a drive source and may be capable of autonomous travel. The base supports the projector 12, the camera (a first sensor) 13, the stereo camera (a second sensor) 14 or the like. The cart 11 may be movable along a rail arranged on the floor, ceiling, or the like. The cart 11 is not an essential component and may be omitted.

The projector 12 is placed on the cart 11. The projector 12 projects the auxiliary image 101 under the control by the controller 20.

The camera 13 and the stereo camera 14 are fixed to the upper surface of the projector 12. As a result, the relative positions of the projector 12, the camera 13, and the stereo camera 14 do not change. In other words, the projector 12, the camera 13, and the stereo camera 14 move integrally. How the projector 12, the camera 13, and the stereo camera 14 are attached may be different from the present embodiment. For example, the projector 12, the camera 13, and the stereo camera 14 may be attached to the cart 11. Alternatively, a support member may be attached to the cart 11 and the projector 12, the camera 13, and the stereo camera 14 may be attached to the support member.

In the following description, directions that the projector 12, the camera 13, and the stereo camera 14 face in are directions that optical axes extend in from them. The optical axis is a straight line extending in an axial direction from a point that passes an optical element (an imaging element, a light emitting element).

The camera 13 is a monocular camera with one imaging element. The direction in which the camera 13 faces (a first direction, see FIG. 1) is substantially the same as the direction in which the projector 12 faces. For example, when the difference in the angles of the optical axes of two objects in a plan view is within 15 degrees or within 10 degrees and the difference in the elevation angles of the optical axes is within 15 degrees or within 10 degrees, the directions of two objects are substantially the same. To explain from another perspective, the optical axis of the camera 13 overlaps with the range in which the projector 12 can project projection light. That is, a space spreading from the projector 12 that the projection light forms and the optical axis of the camera 13 intersects. As described above, since the direction that the camera 13 faces in and the projector 12 faces in are substantially the same, the camera 13 can capture an image projected by the projector 12.

A reference marker 51 and an interpolation marker 52 for position measurement are arranged at appropriate positions in the factory (for example, on the surface of the workpiece 31). The image captured by the camera 13 may include the reference marker 51 and the interpolation marker 52.

The direction in which the stereo camera 14 faces (a second direction, FIG. 1) is different from the first direction and also different from the direction in which the projector 12 faces. For example, when the difference in the angles of the optical axes of two objects in a plan view is 30 degrees or more, 60 degrees or more, or 90 degrees or more, the directions of the two objects are different. (In the present embodiment, the difference in the angles of the optical axes in a plan view is 180 degrees.) Alternatively, directions of two objects may be defined as different when the difference in the elevation angles of the optical axes is 30 degrees or more or 60 degrees or more. Therefore, the stereo camera 14 cannot capture the image projected by the projector 12. The stereo camera 14 captures images of objects, such as an equipment, an apparatus, a tool, or the workpiece 31 arranged in the factory. In FIG. 1, a shelf 53 is shown as an example of an object to be captured by the stereo camera 14.

The stereo camera 14 includes two imaging elements and they capture the workplace individually. The two imaging elements are arranged in an appropriate distance. These imaging elements are, for example, CCDs (Charge Coupled Devices). The two imaging elements operate in synchronization with each other and create a pair of image data by capturing the workplace at the same time. In the present embodiment, since it is supposed that information detected in real time is projected as an auxiliary image, it is preferable that the stereo camera 14 captures an image for more than one time per second, for example.

Furthermore, the stereo camera 14 includes an image processor that processes this pair of image data. The image processor performs a known stereo matching process on the pair of image data obtained by the stereo camera 14 to determine a distance between the positions that the two images correspond to (a disparity). The disparity increases in inverse proportion to the distance to the object captured in the image as the distance becomes shorter. The image processor creates a range image in which each pixel of the image data is linked to information of a distance based on this disparity.

The stereo camera has a configuration in which two imaging elements are arranged within one housing. Alternatively, the stereo camera may be configured by combining two separate cameras. Further, the image processor may be arranged in an apparatus other than the stereo camera 14 (For example, the controller 20).

The controller 20 is a computer that includes a CPU, a ROM, a RAM, and the like. The controller 20 of the present embodiment is arranged at the cart 11. The controller 20 can communicate with the projector 12, the camera 13, and the stereo camera 14 via signal lines not shown in the drawings. The controller 20 may be arranged outside the cart 11. In this case, the controller 20 communicates with the projector 12, the camera 13, and the stereo camera 14 wirelessly, for example.

The controller 20 acquires an image (first environment information) captured by the camera 13 (first acquisition process) and acquires a range image (second environment information) captured by the stereo camera 14 (second acquisition process). The controller 20 creates the auxiliary image 101 based on these information and other information and transmits it to the projector 12. As shown in FIG. 1, the controller 20 includes a communicator 21, an analyzer 22, an image creator 23, and a projection controller 24. Each part that the controller 20 includes is a conceptually divided part of the controller 20 for each process performed by the controller 20 (for each function the controller 20 has). Although the controller 30 of the present embodiment is realized by one computer, the controller 30 may be configured with more than one computer. In this case, these computers are connected via a network.

The communicator 21 is a communication module for communicating with the projector 12, the camera 13, and the stereo camera 14 and includes, for example, a connector for connecting the signal line, an antenna for wireless communication, or the like. The communicator 21 receives the image captured by the camera 13, receives the image captured by the stereo camera 14, and transmits the auxiliary image 101 created by the image creator 23 to the projector 12.

When the reference marker 51 or the interpolation marker 52 is included in the image captured by the camera 13, the analyzer 22 performs a known analysis process based on the position, the size, the degree of distortion, or the like of the reference marker 51 or the interpolation marker 52 to calculate a relative position (self-position) of the camera 13 with respect to the reference marker 51 or the interpolation marker 52. The self-position is a position of an apparatus performing the measurement itself and when the self-position is calculated based on the image captured by the camera 13, the self-position indicates the position of the camera 13 (or the work information projection system 1).

The analyzer 22 also performs a SLAM (Simultaneous Localization and Mapping) process on the range image captured by the stereo camera 14. The analyzer 22 analyzes the range image to create map information (environmental map) that indicates shapes and positions of objects in the workplace and also to estimate the position (self-position) of the stereo camera 14.

Since the SLAM process is well known to the public, it will be briefly described below. That is, the analyzer 22 analyzes the range image, sets an appropriate feature point, and acquires the movement thereof. Then, the analyzer 22 extracts and tracks more than one feature point in the range image to obtain data expressing the movements of the feature points in a plane that corresponds to the image using vectors. The analyzer 22 creates map information based on this data. As described above, the map information is data that indicates a shape and a position of an object in the workplace, and more specifically, it is data that indicates three-dimensional positions of the extracted feature points (point cloud). Furthermore, the analyzer 22 estimates a change in the position of the stereo camera 14 based on a change in the positions and the distances of the input feature points and the positions of the feature points in the map information. The SLAM process may also be performed based on an image captured by a monocular camera with one imaging element. Therefore, a monocular camera may be arranged instead of the stereo camera 14.

The image creator 23 creates the auxiliary image 101. The controller 20 stores work information that is information related to the work. The work information of the present embodiment is the names of the parts to be attached to the workpiece 31 and the positions where the parts should be attached. The image creator 23 creates the work information, the position estimated based on the image captured by the camera 13 or the stereo camera 14, and the auxiliary image 101 to be projected by the projector 12.

The projection controller 24 transmits the auxiliary image 101 created by the image creator 23 to the projector 12 to project the auxiliary image 101. With these configurations described above, the auxiliary image 101 can be projected onto the workplace.

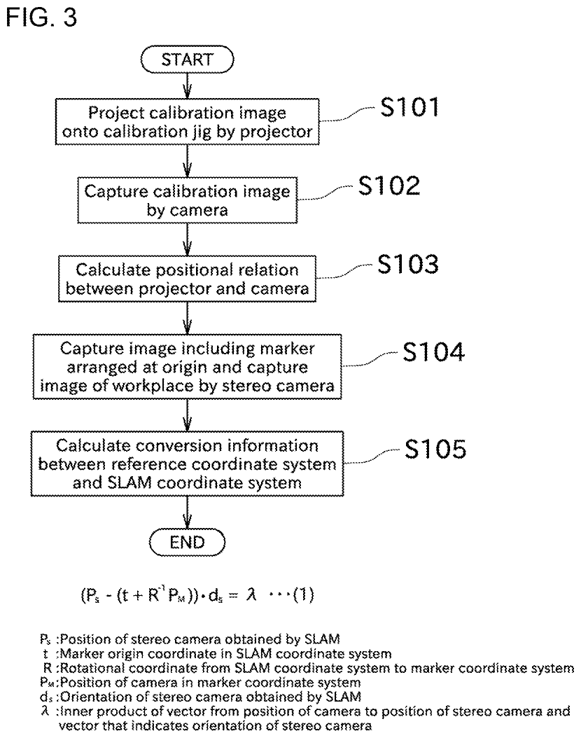

The estimation of the position of the projector 12 will be described in detail below. First, with reference to FIG. 3 to FIG. 5, the calibration process performed before the work will be described below.

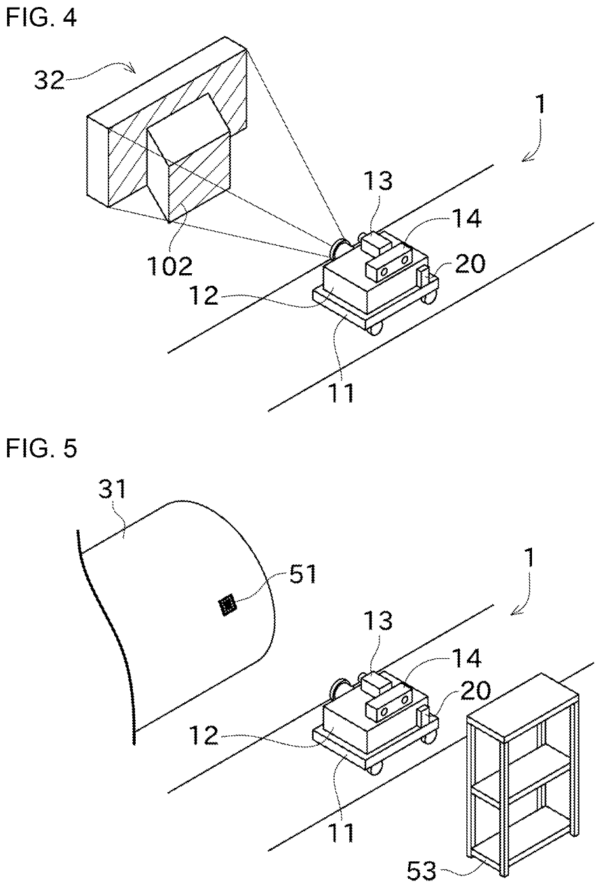

First, a calibration jig 32 is arranged in front of the projector 12. The calibration jig 32 is a member that calibrates the projector 12 and the camera 13. When the controller 20 receives an instruction to start the calibration process, the controller 20 transmits a calibration image 102 to the projector 12. As shown in FIG. 4, the projector 12 then projects the calibration image 102 onto the calibration jig 32 (S101). The camera 13 captures the calibration image 102 projected onto the calibration jig 32 (S102).

Then, the controller 20 performs a known analysis procedure based on the position, the orientation, the size, the degree of distortion or the like of the calibration image 102 included in the image captured by the camera 13 in order to calculate the relative positional relation between the projector 12 and the camera 13 (S103).

Then, the reference marker 51 is arranged. The position where the reference marker 51 is arranged will be the origin of a reference coordinate system (a marker coordinate system). In the present embodiment, a coordinate system that includes a marker (the reference marker 51 or the interpolation marker 52) as the origin is referred to as the marker coordinate system and a coordinate system that includes the reference marker 51 as the origin is particularly referred to as the reference coordinate system. The reference coordinate system is a coordinate system used for describing the above-mentioned work instruction. The position of the origin of the reference coordinate system may be set as desired. However, for example, it is preferable that the origin is set on the workpiece 31 when the work is performed on the workpiece 31. As a result, even when the position of the workpiece 31 slightly changes, the position where the auxiliary image 101 is projected is unlikely to change.

As shown in FIG. 5, after the reference marker 51 is arranged, the camera 13 captures an area including the reference marker 51 and the stereo camera 14 captures the surrounding workplace (S104). Then, the controller 20 calculates conversion information between the reference coordinate system (the marker coordinate system) and a SLAM coordinate system (S105).

The conversion information is information used for performing coordinate conversion between the reference coordinate system and the SLAM coordinate system. In other words, the conversion information is information that indicates the positional relation between the camera 13 and the stereo camera 14. Based on the position, the size, the degree of distortion, or the like of the reference marker 51 included in the image captured by the camera 13, the controller 20 calculates the position of the camera 13 with respect to the reference marker 51 (that is, the position in the reference coordinate system). The controller 20 performs the SLAM process as described above based on the range image captured by the stereo camera 14 in order to calculate the position of the stereo camera 14 in the SLAM coordinate system. Then, with the position of the camera 13 in the reference coordinate system and the position of the stereo camera 14 in the SLAM coordinate system that are calculated based on the image and the range image captured at the same time as a pair of positional information, the controller 20 calculates more than one pair of the positional information.

Based on the pairs of the positional information calculated as described above, the conversion information is created. Specifically, the conversion information is calculated based on an equation (1) shown in FIG. 3. The left-hand side of the equation (1) indicates the inner product of “a vector from the position of the camera 13 to the position of the stereo camera 14” and “a vector that indicates the orientation of the stereo camera 14”. Since the camera 13 and the stereo camera 14 do not move relative to each other, λ, the value of the inner product, is constant. Therefore, by substituting multiple pairs of the positional information into the equation (1), a marker origin coordinate (t) in the SLAM coordinate system and rotational coordinates (R) from the SLAM coordinate system to the marker coordinate system can be calculated. These values correspond to the conversion information.

By using the conversion information, the position and the orientation of the stereo camera 14 in the SLAM coordinate system estimated by performing the SLAM process can be converted into the reference coordinates. Specifically, the position of the stereo camera 14 in the reference coordinate system is indicated as R(Pₛ-T) and the orientation of the stereo camera 14 is indicated as Rds. By performing similar calculations, conversion information for converting the marker origin coordinate system into the SLAM coordinate system can also be calculated.

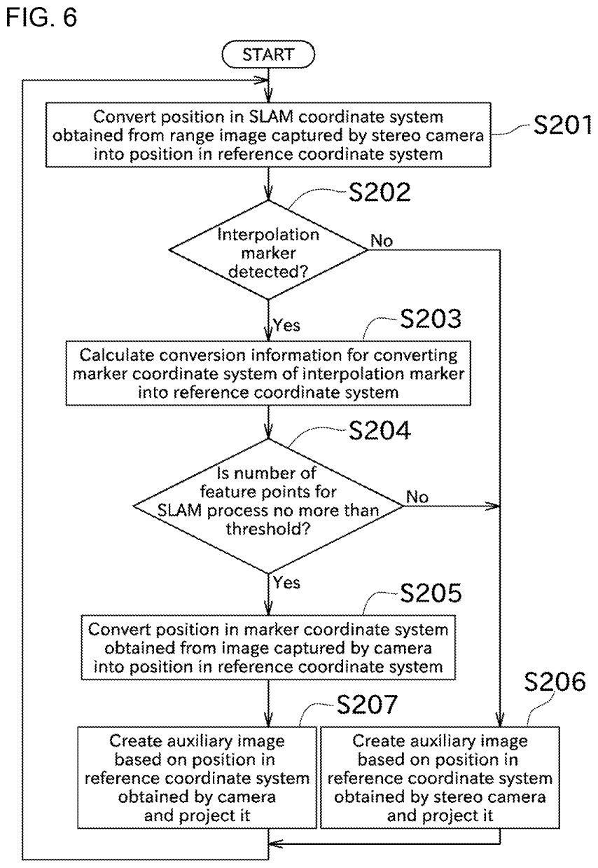

Next, the process performed during the work will be described below with reference to FIG. 6 to FIG. 8. In the following description, estimation of a position by performing the SLAM process based on the range image captured by the stereo camera 14 will be referred to as a SLAM measurement. Estimation of a position based on the interpolation marker 52 included in an image captured by the camera 13 will be referred to as a marker measurement.

A base measurement process of the present embodiment is the SLAM measurement and when the SLAM measurement cannot be performed properly, the marker measurement is performed. A case where the SLAM measurement cannot be performed properly is a case where the stereo camera 14 cannot acquire appropriate information. Specifically, it is, for example, a case where the stereo camera 14 captures only a flat wall and few feature points are included in it. This will be explained in detail below.

The controller 20 estimates the position in the SLAM coordinate system based on the range image captured by the stereo camera 14 and converts it into the position in the reference coordinate system by using the conversion information calculated in the calibration process (S201, a position estimation process). Then, the controller 20 determines whether the interpolation marker 52 is included in the image captured by the camera 13 (S202).

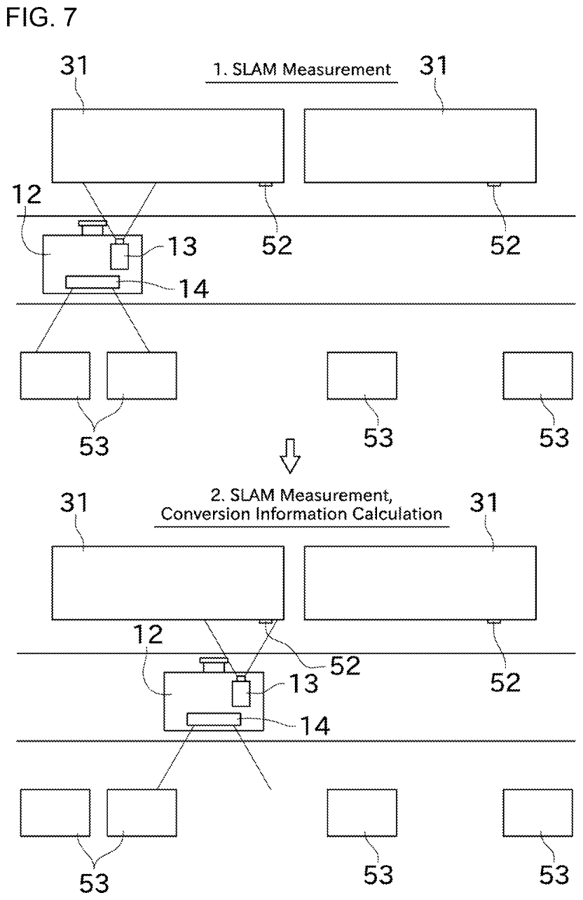

In a situation described as “1. SLAM Measurement” in FIG. 7, the interpolation marker 52 is not included in the image captured by the camera 13. In such a case, the controller 20 creates the auxiliary image 101 based on the position in the reference coordinate system obtained by the stereo camera and projects it by the projector 12 (S206).

In a situation described as “2. SLAM Measurement, Conversion Information Calculation” in FIG. 7, the interpolation marker 52 is included in the image captured by the camera 13. In such a case, the controller 20 calculates the conversion information for converting the marker coordinate system of the interpolation marker 52 into the reference coordinate system (S203). The process of calculating this conversion information is the same as the step S105 in the calibration process. That is, since both the positions in the marker coordinate system that includes the interpolation marker 52 as the origin and the positions in the SLAM coordinate system are obtained, they are combined as pairs and substituted into the equation (1). In this manner, the conversion information for converting the marker coordinate system of the interpolation marker 52 into the SLAM coordinate system can be calculated. Furthermore, the conversion information for converting the SLAM coordinate system into the reference coordinate system has already been calculated in the step S105. Therefore, by combining these two conversion information, conversion information for converting the marker coordinate system of the interpolation marker 52 into the reference coordinate system can be calculated.

Then, the controller 20 determines whether the number of the feature points for the SLAM process is no more than a threshold (S204). In other words, the controller 20 determines whether the second environment information has been acquired. In the situation described as “2. SLAM Measurement, Conversion Information Calculation” in FIG. 7, there are a sufficient number of the feature points because the stereo camera 14 detects the shelf 53. In such a case, the position measurement using the interpolation maker 52 is not used, but the position measurement based on the SLAM measurement is used. That is, the controller 20 creates the auxiliary image 101 based on the position in the reference coordinate system obtained by the stereo camera 14 and projects it by the projector 12 (S206).

In other words, there is a determination condition for determining whether the information acquired by the stereo camera 14 or the information calculated based on it is appropriate or not and the controller 20 determines whether the determination condition is satisfied in the step S204.

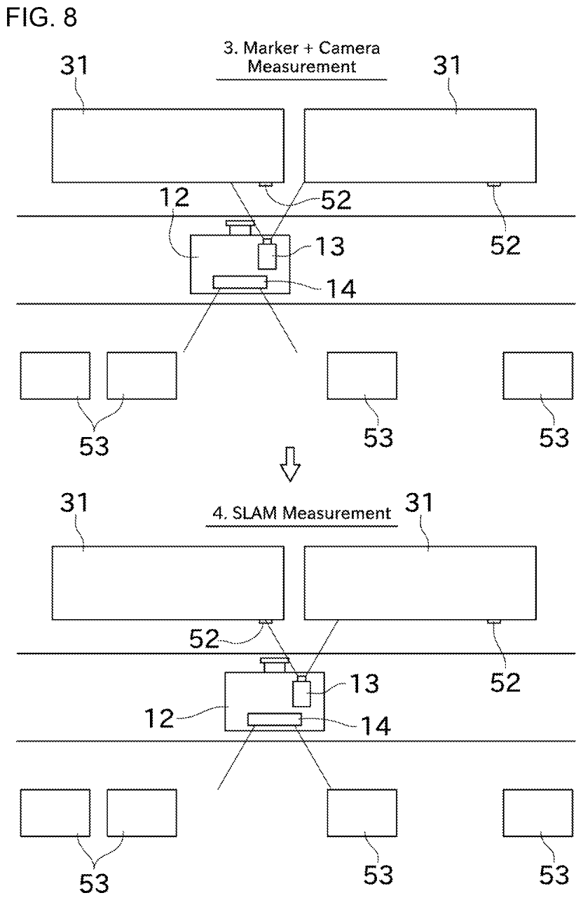

In a situation described as “3. Marker+Camera Measurement” in FIG. 8, there is no object such as the shelf 53 in the range the stereo camera 14 captures, so the number of the feature points for the SLAM process is no more than the threshold. In such a case, the position measurement based on the SLAM measurement is not used, but the position measurement using the interpolation maker 52 is used. Therefore, the controller 20 converts the position in the marker coordinate system obtained from the image captured by the camera 13 (the image that includes the interpolation marker 52) to the position in the reference coordinate system (S205, a position estimation process). This conversion is performed using the conversion information calculated in step the S203. Then, the controller 20 creates the auxiliary image 101 based on the position in the reference coordinate system obtained by the camera 13 and projects it by the projector 12 (S207).

A situation in which the feature points for the SLAM process becomes no more than the threshold can be predicted in advance. Therefore, in the present embodiment, the interpolation marker 52 is arranged close to the position at which the camera 13 is in the situation where the feature points for the SLAM process becomes no more than the threshold. This makes it possible to perform at least one of the SLAM measurement or the marker measurement.

The flowchart shown in FIG. 6 is repeatedly executed. Therefore, when a situation described as “4. SLAM Measurement” in FIG. 8 occurs after the situation described as “3. Marker+Camera Measurement” in FIG. 8, that is, when the number of the feature points for the SLAM process exceeds the threshold, the position measurement using the interpolation marker 52 is stopped and the position measurement based on the SLAM measurement is used.

As described above, while being based on the SLAM measurement, the position estimation in the work place can be kept performed with a high accuracy by performing the marker measurement in a situation where the accuracy of the position estimation by the SLAM measurement becomes low.

As described above, the work information projection system 1 of the present embodiment performs the position estimation method for estimating a position in the workplace. The work information projection system 1 includes the camera 14, the stereo camera 14, and the controller 20. The camera 13 is arranged facing in the first direction and acquires the first environment information which is information about objects arranged in the first direction and around (the first direction). The stereo camera 14 is arranged facing in the second direction and acquires the second environment information which is information about objects arranged in the second direction and around (the second direction). The controller can calculate a self-position in the first coordinate system based on the first environment information and can calculate a self-position in the second coordinate system based on the second environment information. The controller 20 estimates the position in the first coordinate system based on the first environment information when the second environment information becomes unacquirable.

This allows the estimation of the position in the workplace to be continued even when the stereo camera 14 becomes unable to acquire the environment information.

In the position estimation system of the present embodiment, the stereo camera 14 is so arranged that it moves integrally with the camera 13.

This allows the position estimation in the workplace to be performed more appropriately because the positional relation between the camera 13 and the stereo camera 14 does not change.

In the position estimation system of the present embodiment, the first direction and the second direction are different directions.

This allows one sensor to complement the other sensor because the ranges of detection of the camera 13 and the stereo camera 14 are significantly different.

In the work information projection system 1 of the present embodiment, the controller 20 calculates the conversion information for converting the first coordinate system and the second coordinate system when it determines that the first environment information and the second environment information are acquirable.

This allows the continuous usage of the same coordinate system even when the sensor used for the position measurement is changed.

The work information projection system 1 of the present embodiment includes the projector 12 that projects the auxiliary image 101 that assists the work onto the workplace. The controller 20 creates the auxiliary image 101 according to the position in the workplace and transmits the auxiliary image 101 to the projector 12.

This allows the assistance to the worker with the work. In particular, the work information projection system 1 of the present embodiment does not easily lose sight of its self-position, so high reliability can be achieved.

In the work information projection system 1 of the present embodiment, the optical axis of the camera 13 overlaps with the range in which the projector 12 can project the auxiliary image 101. The camera 13 is the camera 13 that captures an image of an area including the marker arranged in the workplace. The stereo camera 14 is the stereo camera 14 that captures an image of an object arranged in and around the second direction.

This prevents the stereo camera 14 from capturing the auxiliary image 101 projected by the projector 12, so the auxiliary image 101 can be prevented from being recognized as a feature point.

In the work information projection system 1 of the present embodiment, the controller 20 calculates the conversion information for converting the first coordinate system and the second coordinate system when it determines that the first environment information and the second environment information are acquirable while the projector 12 is projecting the auxiliary image 101 onto the workplace during the work.

This allows the requisite conversion information to be calculated during the work, so the effort required for the preparation in advance can be reduced.

In the position estimation system of the present embodiment, the conversion information is calculated based on the equation that calculates the inner product of the vector from the position of the camera 13 to the position of the stereo camera 14 and the vector that indicates the orientation of the stereo camera 14.

This allows the conversion information to be calculated with simple processes.

Although a preferred embodiment of the present invention has been described above, the above-described configurations can be modified, for example, as follows.

In the above embodiment, the first sensor facing in the direction substantially the same as the direction that the projector 12 faces in is the camera 13 and the second sensor arranged on the opposite side is the stereo camera 14. Alternatively, the first sensor may be the stereo camera 14 and the second sensor may be the camera 13. In this case, the interpolation marker 52 is arranged at an appropriate position in the workplace instead of on the workpiece 31.

In the above embodiment, the first sensor and the second sensor (that is, the camera 13 and the stereo camera 14) face in different directions. Alternatively, as long as the ranges of detection of the first sensor and the second sensor are different (for example, the detection distances, the widths of the detection ranges in a horizontal direction, or the widths of the detection ranges in a vertical direction are different), the first sensor and the second sensor may face in the same direction. In other words, the first direction and the second direction may be the same direction. In this case, since the second sensor can detect the range that cannot be detected by the first sensor, the same processes as in the above embodiment can be applied.

Although the above embodiment is described mentioning the stereo camera 14 as an example of a three-dimensional measurement apparatus, another apparatus, such as LiDAR (Light Detection and Ranging) may be used. LIDAR is a technology that acquires a position and a shape of a surrounding object or the like by emitting radio waves in various directions and measuring the times until the reflected radio waves thereof are received.

The flowcharts shown in the above embodiment are disclosed just as examples and some processes may be omitted, the contents of some processes may be changed, or new processes may be added. For example, although the SLAM measurement is performed preferentially compared to the marker measurement in the above embodiment as shown in FIG. 6, but the marker measurement may be performed preferentially. That is, the marker measurement is always performed when the interpolation marker 52 is included in the image captured by the camera 13 and the SLAM measurement is performed when the interpolation marker 52 is not included in the image captured by the camera 13.

Although the process of converting the estimated position into the reference coordinate system is performed in the above embodiment, this process may be omitted.

The position estimation system of the present invention can be applied to various systems that estimate the self-position, not limited to the work information projection system. For example, the present invention can be applied to a traveling system for autonomous locomotion.

### DESCRIPTION OF THE REFERENCE SIGNS

1 Work information projection system (position recognition system)
11 Cart
12 Projector
13 Camera (first sensor)
14 Stereo camera (second sensor, three-dimensional measurement apparatus)
20 Controller

1. A position estimation system that estimates a position in a workplace, comprising:
a first sensor that is arranged facing in a first direction and acquires first environment information which is information about an object arranged in and around the first direction;
a second sensor that is arranged facing in a second direction and acquires second environment information which is information about an object arranged in and around the second direction;
a memory, and
a controller configured to calculate a self-position in a first coordinate system based on the first environment information, can calculate a self-position in a second coordinate system based on the second environment information, and estimates a self-position based on the first environment information when the second environment information becomes unacquirable.

2. The position estimation system according to claim 1, wherein:
the second sensor is so arranged that it moves integrally with the first sensor.

3. The position estimation system according to claim 1, wherein:
the first direction and the second direction are different directions.

4. The position estimation system according to any one of claim 1, wherein:
the controller calculates conversion information for converting the first coordinate system and the second coordinate system when the first environment information and the second environment information are acquirable.

5. The position estimation system according to claim 1, further comprising:
a projector that projects an auxiliary image that assists a work onto the workplace,
wherein the controller creates the auxiliary image according to a position in the workplace and transmits the auxiliary image to the projector.

6. The position estimation system according to claim 5, wherein:
an optical axis of the first sensor overlaps with a range in which the projector can project the auxiliary image,
the first sensor is a camera that captures an image of an area including a marker arranged in the workplace, and
the second sensor is a three-dimensional measurement sensor that acquires a shape and a position of an object arranged in and around the second direction.

7. The position estimation system according to claim 6, wherein:
the controller calculates conversion information for converting the first coordinate system and the second coordinate system when the first environment information and the second environment information are acquirable while the projector is projecting the auxiliary image onto the workplace during the work.

8. The position estimation system according to claim 4, wherein;
the conversion information is calculated based on an equation that calculates an inner product of a vector from a position of the first sensor to a position of the second sensor and a vector that indicates an orientation of the second sensor.

9. A position estimation method, comprising:
acquiring first environment information which is information about an object arranged in and around a first direction is acquired by a first sensor arranged in a workplace facing in the first direction;
acquiring second environment information which is information about an object arranged in and around a second direction is acquired by a second sensor arranged in the workplace facing in the second direction; and
estimating a self-position based on the first environment information when the second environment information becomes unacquirable.
